(19) United States
(12) Patent Application Publication
(10) Pub. No.: US 2008/0279268 A1
(43) Pub. Date: Nov. 13, 2008

(54) Method for measuring noise, apparatus for measuring noise, and program for measuring noise

(75) Inventors: Junichi Iwai, Hyogo (JP); Koji Murata, Hyogo (JP)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC.

(21) Appl. No.: 11/801,671

(22) Filed: May 10, 2007

(51) Int. Cl. H04B 3/46

(52) U.S. Cl. 375/227

(57) ABSTRACT

The frequency of signals under test is stabilized and the noise components of the signals under test whose frequency has been stabilized is measured. When the noise of the object under test is related to frequency or phase, the measured noise components are corrected based on the properties of frequency stabilization.

### BACKGROUND

1. Field of the Disclosure

The present disclosure relates to technology for measuring the noise components of signals, such as PM noise or AM noise, and in particular, to technology for measuring the noise components of signals having a large frequency drift.

2. Discussion of the Background Art

The quality of the output signals of a signal source for creating monofrequency signals, such as a quartz oscillator or a voltage-controlled oscillator, is determined by PM noise, which is also referred to as phase noise, AM noise, which is also referred to as amplitude noise, and the like. PM noise is measured, for instance, by detecting the phase components of signals under test using a phase detector and further subjecting the output signals of the phase detector to spectrum analysis (for instance, refer to JP Unexamined Patent Publication (Kokai) 4-350576 (page 2, FIG. 4), JP Unexamined Patent Publication (Kokai) 2003-287555 (page 2, FIG. 4), and JP Unexamined Patent Publication (Kokai) 2005-308511 (pages 5 through 8, FIG. 1, FIG. 2)). Moreover, AM noise is measured, for instance, by detecting the amplitude components of signals under test using a square-law detector and further subjecting the output signals of the square-law detector to spectrum analysis (for instance, refer to JP Unexamined Patent Publication (Kokai) 4-350576 (page 2, FIG. 4)).

Additional prior art can be found in Jan Li, and three others, Review of PM and AM Noise Measurement System, Microwave and Millimeter Wave Technology Proceedings, ICMMT International Conference on Microwave and Millimeter Wave Technology, 1998, p. 197-200

The accuracy of noise measurement deteriorates as the frequency drift of the signals under test increases. Moreover, it becomes impossible to measure the frequency of signals under test when drift increases beyond a certain constant amount. Consequently, there is a need for a technology for measuring with the desired accuracy the noise components of signals whose frequency drift increases to the extent that they cannot be measured with this desired accuracy by the prior art.

### SUMMARY OF THE DISCLOSURE

The present disclosure was intended to solve the above-mentioned problem, and is as described below. In essence, the first subject of the invention is a method for measuring the noise components of signals under test characterized in that it comprises a step for stabilizing the frequency of the signals under test, and a step for measuring the noise components of the signals under test whose frequency has been stabilized.

The second subject of the invention is the method of the first subject of the invention, further characterized in that it comprises a step for correcting the measured noise components based on the properties of frequency stabilization.

The third subject of the invention is the method of the first subject of the invention, further characterized in that the stabilizing step comprises a step for generating local signals; a step for converting the frequency of the signals under test using the local signals; a step for detecting the frequency of the signals under test, or the frequency of the signals under test whose frequency has been converted; and a step for controlling the frequency of the local signals based on the detected frequency.

The fourth subject of the invention is the method of the first subject of the invention, further characterized in that the noise components are PM noise or AM noise.

The fifth subject of the invention is an apparatus for measuring noise, characterized in that it comprises: a frequency stabilizing unit for stabilizing the frequency of signals under test, and a noise measuring unit for measuring the noise components of the signals under test whose frequency has been stabilized by the frequency stabilizing unit.

The sixth subject of the invention is the apparatus of the fifth subject of the invention, further characterized in that it comprises an arithmetic unit for correcting the measurement results of the noise measuring unit based on the properties of frequency stabilization by the frequency stabilizing unit.

The seventh subject of the invention is the apparatus of the fifth subject of the invention, further characterized in that the frequency stabilizing unit comprises a signal source, a frequency converter to which the output signals of the signal source are fed, and a frequency detector; the frequency detector detects the frequency of the signals under test or the output signals of the frequency converter; and the frequency of the output signals of the signal source is controlled based on the frequency detected by the frequency detector.

The eighth subject of the invention is the apparatus of the fifth subject of the invention, further characterized in that the noise components are PM noise or AM noise.

### EFFECT OF THE INVENTION

The present disclosure raises the allowance for frequency drift in noise measurement. In essence, it is possible to measure with the desired accuracy the noise components even of signals having such a large frequency drift that they cannot be measured with this desired accuracy by the prior art.

### BRIEF DESCRIPTION OF THE DRAWINGS

FIG. 1 is a block diagram showing apparatus 1 for measuring noise that is an embodiment of the present disclosure.

FIG. 2A is a block diagram showing an example of frequency stabilizing unit 20.

FIG. 2B is a block diagram showing another example of frequency stabilizing unit 20.

FIG. 3 is a block diagram showing the apparatus 2 for measuring noise that is an embodiment of the present disclosure.

FIG. 4A is a drawing showing the effect of the present disclosure.

FIG. 4B is a drawing showing the effect of the present disclosure.

### DETAILED DESCRIPTION OF THE PREFERRED EMBODIMENT

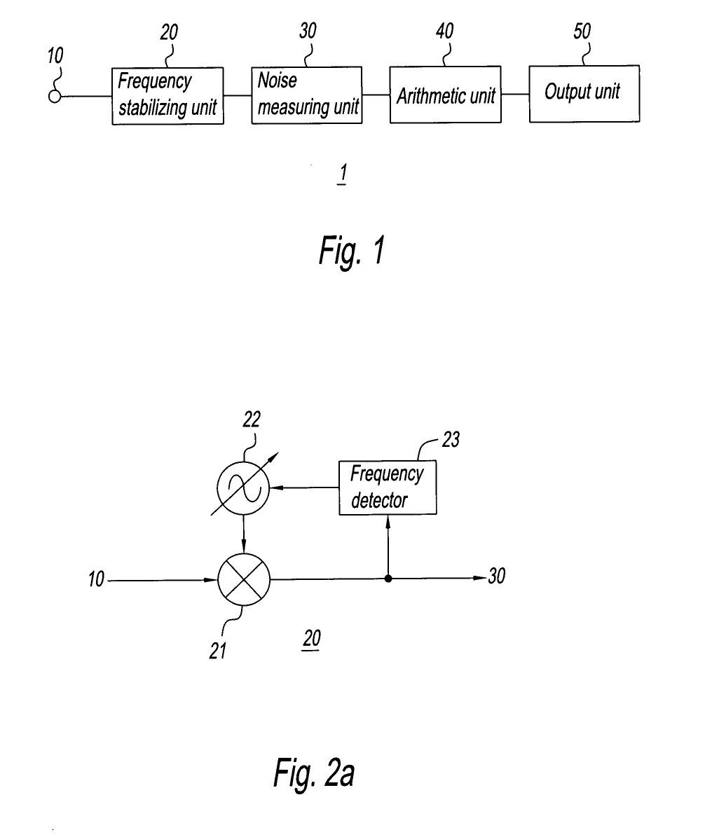

Embodiments of the present disclosure will now be described while referring to the attached drawings. Refer to FIG. 1. FIG. 1 is a block diagram of an apparatus 1 for measuring noise, which is the first embodiment of the present disclosure. Apparatus 1 for measuring noise in FIG. 1 comprises an input terminal 10, a frequency stabilizing unit 20, a noise measuring unit 30, an arithmetic unit 40, and an output unit 50. Input terminal 10 is the terminal for receiving signals under test. Frequency stabilizing unit 20 is the unit for stabilizing the frequency of the signals under test, in essence, the unit for controlling the frequency drift of the signals under test. Hereafter the signals under test whose frequency has been stabilized by frequency stabilizing unit 20 are simply referred to as stabilized signals. The stabilized signals are output from frequency stabilizing unit 20. Noise measuring unit 30 is a unit for measuring the noise components of the stabilized signals. The noise components are PM noise, AM noise, and the like. Arithmetic unit 40 is the unit for correcting the measurement results of noise measuring unit 30. Correction by arithmetic unit 40 is based on the properties of frequency stabilization (in essence, frequency drift control) of the frequency stabilizing unit. This correction is applied when the noise of the object under test is related to frequency or phase. There are cases wherein when the noise of the object under test is related to frequency or phase, the noise measurement results may be affected by frequency stabilization. However, the effect of frequency stabilization on the noise measurement results is compensated or canceled by correction by arithmetic unit 40. Output unit 50 is the unit for outputting the measurement result corrected by arithmetic unit 40.

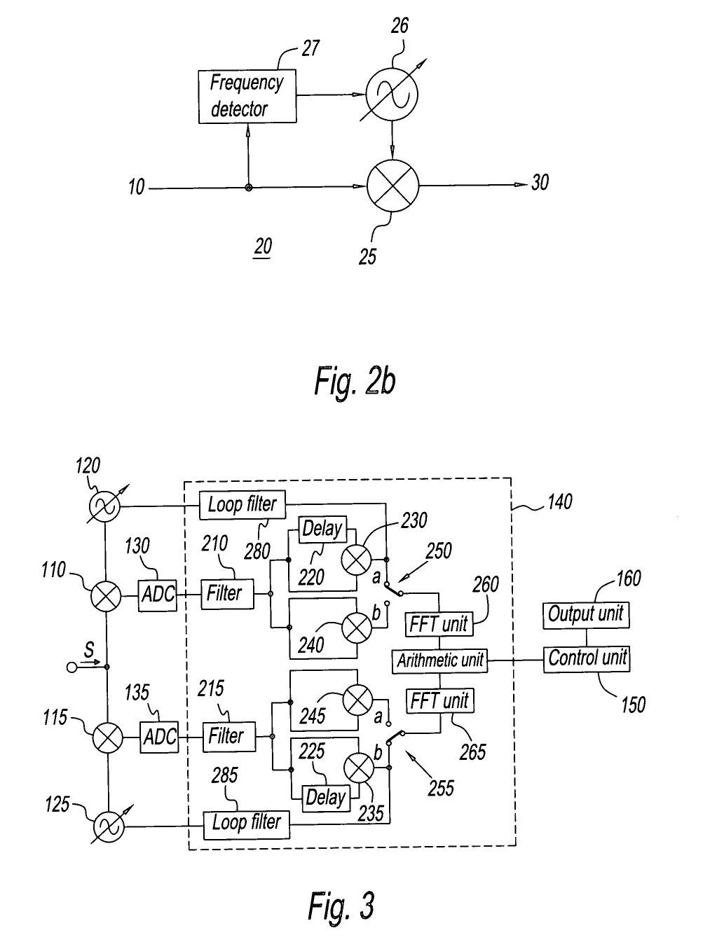

The structure of frequency stabilizing unit 20 will now be described in further detail. Refer to FIG. 2A. FIG. 2A is a drawing showing an example of the structure of frequency stabilizing unit 20. Frequency stabilizing unit 20 in FIG. 2A comprises a mixer 21, a signal source 22, and a frequency detector 23. Mixer 21 is the unit for mixing signals under test received at input terminal 10 and output signals of signal source 22 and outputting the mixing results. Frequency detector 23 is the unit for detecting the frequency of the output signals of mixer 21 and outputting the detection results. The detection results of frequency detector 23 are fed to signal source 22. Signal source 22 changes the frequency of the output signals of signal source 22 in accordance with the frequency detected by frequency detector 23. Or, frequency detector 23 controls signal source 22 based on the frequency detected by frequency detector 23 in such a way that the frequency of the output signals of signal source 22 change. Although not illustrated, there may also be a control unit disposed between frequency detector 23 and signal source 22, and this control unit can control signal source 22 based on the frequency detected by frequency detector 23 in such a way that the frequency of the output signals of signal source 22 change. In either case, the frequency of the output signals of signal source 22 change such that the frequency fluctuations of the output signals of mixer 21 are kept within a predetermined frequency range. The predetermined frequency range is established based on the measurement theory of noise measuring unit 30 shown in FIG. 1, the capability of the parts that form noise measuring unit 30 shown in FIG. 1, the desired noise measurement accuracy, and the like.

Next, refer to FIG. 2B. FIG. 2B is a drawing showing another example of the structure of frequency stabilizing unit 20. Frequency stabilizing unit 20 in FIG. 2B comprises a mixer 25, a signal source 26, and a frequency detector 27. Mixer 25 is the unit for mixing the signals under test received at input terminal 10 and the output signals of signal source 26 and outputting the mixing results. Frequency detector 27 is the unit for detecting the frequency of the signals under test received at input terminal 10 and outputting the detection results. The detection results of frequency detector 27 are fed to signal source 26. Signal source 26 changes the frequency of the output signals in accordance with the frequency detected by frequency detector 27. Or, frequency detector 27 controls signal source 26 based on the frequency detected by frequency detector 27 in such a way that the frequency of the output signals of signal source 26 change. Although not illustrated, it is also possible to dispose a control unit between frequency detector 27 and signal source 26 and to control signal source 26 based on the frequency detected by frequency detector 27 in such a way that the frequency of the output signals of signal source 26 change. In either case, the frequency of the output signals of signal source 26 change such that the frequency fluctuations of the output signals of mixer 25 are kept within a predetermined frequency range. The predetermined frequency range is established based on the measurement theory of noise measuring unit 30 shown in FIG. 1, the capability of the parts that form noise measuring unit 30 shown in FIG. 1, the desired noise measurement accuracy, and the like.

The group consisting of mixer 21, signal source 22, and frequency detector 23 forms a frequency locked loop. Moreover, the group consisting of mixer 25, signal source 26, and frequency detector 27 forms a frequency locked loop. These frequency locked loops have predetermined loop properties. This loop property is referred to as the frequency stabilizing property for correction by arithmetic unit 40 in FIG. 1.

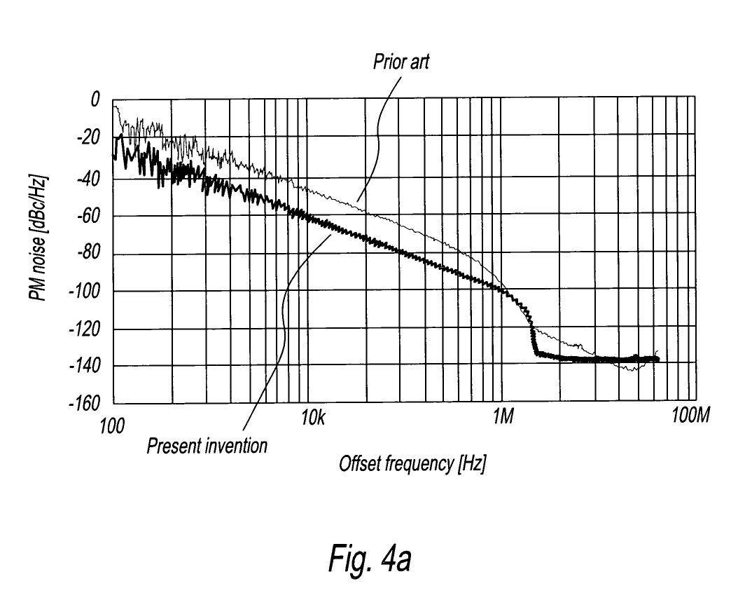

Next, an embodiment wherein the present disclosure is employed for the measurement of PM noise and AM noise using correlation processing will now be described while referring to the attached drawings. FIG. 3 is a block diagram of apparatus 2 for measuring noise, which is the second embodiment of the present disclosure. Apparatus 2 for measuring noise is an apparatus for measuring the PM noise and the AM noise of signals under test. Apparatus 2 for measuring noise in FIG. 3 comprises an input terminal 100, a mixer 110, a mixer 115, a signal source 120, a signal source 125, an analog-to-digital converter 130, an analog-to-digital converter 135, a processor 140, a control unit 150, and an output unit 160. The analog-to-digital converters are hereafter referred to as ADCs.

Input terminal 100 is the terminal for receiving signals under test S. Mixer 110 is the unit for mixing the signals under test S received at input terminal 100 with the output signals of signal source 120 and outputting the mixing results. Mixer 115 is the unit for mixing the signals under test S received at input terminal 100 with the output signals of signal source 125 and outputting the mixing results. ADC 130 is the unit for digitalizing the output signals of mixer 110 and outputting the digitalization results. ADC 135 is the apparatus for digitalizing the output signals of mixer 115 and outputting the digitalization results. Processor 140 is the unit for processing the digital data output by ADC 130 and ADC 135. Processor 140 measures the noise components of the signals digitalized by ADC 130 and ADC 135 and outputs those measurement results. Moreover, processor 140 is the unit for detecting the frequency of the signals digitalized by ADC 130 and ADC 135. Processor 140 consists of, for instance, a CPU, an MPU, a DSP, a programmable gate array, and the like. Control unit 150 is the unit for controlling each of the structural elements inside noise measuring unit 2. Control unit 150, for instance, outputs the noise measurement results of processor 140 to output unit 160, or stores the noise measurement results of processor 140 in a memory that is not illustrated. Output unit 160 comprises, for instance, a display, a printer, a network unit, or similar unit.

The inside of processor 140 will now be described in detail. Processor 140 comprises a filter 210, a filter 215, a delay 220, a delay 225, a mixer 230, a mixer 235, a mixer 240, a mixer 245, a switch 250, a switch 255, a fast Fourier transform unit 260, a fast Fourier transform unit 265, an arithmetic unit 270, a loop filter 280, and a loop filter 285. These structural elements inside processor 140 are realized inside processor 140 as hardware or software as a result of processor 140 executing or reading a program stored in a memory that is not illustrated, or the processor being programmed by control unit 150 or another control unit that is not illustrated. The fast Fourier transform unit is called an FFT unit hereafter.

Filter 210 is a unit for filtering the signals digitalized by ADC 130 and outputting the filtration results. The group consisting of mixer 110, signal source 120, ADC 130, and filter 210 acts as a down converter in the present embodiment. It should be noted that the filtration properties of filter 210 can be modified such that the group consisting of mixer 110, signal source 120, ADC 130, and filter 210 acts as an up converter.

Filter 215 is a unit for filtering the signals digitalized by ADC 135 and outputting the filtration results. The group consisting of mixer 115, signal source 125, ADC 135, and filter 215 acts as a down converter in the present embodiment. It should be noted that the filtration properties of filter 215 can be modified such that the group consisting of mixer 115, signal source 125, ADC 135, and filter 215 acts as an up converter.

Delay 220 is an apparatus for delaying the signals and shifting the phase of the signals. The phase of the output signals of filter 210 is shifted by an odd-number multiple of 90 degrees when the signals pass through delay 220. Mixer 230 is a unit for mixing the output signals from filter 210 with the output signals from delay 220 and outputting the mixing results. The group consisting of delay 220 and mixer 230 acts as a phase detector, or as a frequency detector. The output signals of mixer 230 are filtered by loop filter 280 and then fed to signal source 120. The group consisting of mixer 110, signal source 120, ADC 130, filter 210, delay 220, mixer 230, and loop filter 280 forms a frequency locked loop and acts as an unit for stabilizing frequency. The fluctuations in frequency of the output signals of mixer 110 are controlled by this frequency locked loop in such a way that they are kept within a predetermined frequency range.

Delay 225 is an apparatus for delaying the signals and shifting the phase of the signals. The phase of the output signals of filter 215 are shifted by an odd-number multiple of 90 degrees when the signals pass through delay 225. Mixer 235 is a unit for mixing the output signals from filter 215 with the output signals from delay 225 and outputting the mixing results. The group consisting of delay 225 and mixer 235 acts as a phase detector, or as a frequency detector. The output signals of mixer 235 are filtered by loop filter 285 and then fed to signal source 125. The group consisting of mixer 115, signal source 125, ADC 135, filter 215, delay 225, mixer 235, and loop filter 285 forms a frequency locked loop and acts as a unit for stabilizing frequency. The fluctuations in frequency of the output signals of mixer 115 are controlled by this frequency locked loop such that they are kept within a predetermined frequency range.

Mixer 240 is a unit for squaring the output signals of filter 210 and outputting the squaring results. Mixer 240 acts as a square-law detector.

Mixer 245 is a unit for squaring the output signals of filter 215 and outputting the squaring results. Mixer 245 acts as a square-law detector.

Switch 250 is a 1-pole 2-throw (1P2T)-type switch, and is a unit for selectively supplying either the output signals of mixer 230 or the output signals of mixer 240 to FFT unit 260. When PM noise is to be measured, terminal a is selected and when AM noise is to be measured, terminal b is selected. FFT unit 260 is a unit for fast Fourier transform-based conversion of signals fed from switch 250 and outputs the conversion results.

Switch 255 is a 1-pole 2-throw (1P2T)-type switch, and is a unit for selectively supplying either the output signals of mixer 235 or the output signals of mixer 245 to FFT unit 265. When PM noise is to be measured, terminal a is selected and when AM noise is to be measured, terminal b is selected. FFT unit 265 is a unit for fast Fourier transform-based conversion of signals fed from switch 255 and outputs the conversion results.

Arithmetic unit 270 is a unit for calculating C(f)=(A(f)×B*(f)) when one of the transformation results of FFT unit 260 and the transformation results of FFT unit 265 serves as A(f) and the other serves as B(f). Here f is frequency and B*(f) is a complex conjugate of B(f). It should be noted that frequency f is also called offset frequency. Moreover, arithmetic unit 270 further corrects squaring results C(f) when PM noise is to be measured. Correction is accomplished by multiplication of the inverse of the loop transmission properties of the above-mentioned frequency locked loop. For instance, when both loop filter 280 and loop filter 285 are first-order integrators having zero points at frequency f_{z}, both loop filter 280 and loop filter 285 have the same properties, and these properties are dominant over the loop transmission properties of the frequency locked loop; correction is accomplished by dividing C(f) by a(f). As a result, D(f)=C(f)/α(f). It should be noted that α(f) is a function representing the properties of loop filter 280 and loop filter 285, and is a function representing the loop transmission properties of the frequency locked loop. As will be understood by the skilled person, α(f) may be expressed by another function depending on the property of the frequency locked loop

$$α ( f ) = \frac{{A}^{2}}{2} \frac{\frac{f}{{f}_{BW}}}{\sqrt{1 + {( \frac{{f}_{BW} + {f}_{z}}{{f}_{BW} {f}_{z}} f )}^{2}}} \qquad ( Mathematical formula 1 )$$

A is the detector input level, in essence, the amplitude of signals input to mixer 230 or mixer 235. Moreover, f_{BW} is the −3 dB bandwidth of the frequency locked loop. Arithmetic unit 270 outputs C(f) when AM noise is to be measured and D(f) when PM noise is to be measured. These outputs are output to output unit 160, or stored in a memory that is not illustrated, as the results of noise measurement by processor 140.

When the properties of the frequency locked loop relating to loop filter 280 and the properties of the frequency locked loop relating to loop filter 285 are different, arithmetic unit 270 is modified as follows. When PM noise is to be measured, first arithmetic unit 270 corrects the conversion results of FFT unit 260 and the conversion results of FFT unit 265. For instance, when the conversion results of FFT unit 260 are represented by M(f), the conversion results of FFT unit 265 are represented by N(f), the properties of the frequency locked loop relating to loop filter 280 are represented by α_{M}(f), and the properties of the frequency locked loop relating to loop filter 285 are represented by α_{N}(f), arithmetic unit 270 calculates M_{c}(f)=M(f)×α_{M}(f) and N_{c}(f)=N(f)×α_{N}(f). Furthermore, arithmetic unit 270 calculates (M_{c}(f)×N_{c}*(f)) or (M_{c}*(f)×N_{c}(f)) and outputs this calculation result. Or, when AM noise is to be measured, arithmetic unit 270 calculates (M(f)×N*(f)) or (M*(f)×N(f)) without correction and outputs the calculation results. M*(f), N* (f), M_{c}*(f), and N_{c}*(f) are the complex conjugates of M(f), N(f), M_{c}(f) and N_{c}(f).

By means of the second embodiment, quadrature detection is performed in order to measure PM noise, and square-law detection is performed in order to measure AM noise. This present disclosure is not limited to these detection systems. That is, the present disclosure is just as effective when another detection system is used to measure PM noise or AM noise. For instance, the present disclosure is effective for phase detection by PLL in order to measure PM noise. It is possible to stabilize the frequency of the signals under test and correct the measurement results as necessary before noise measurement as described in the first embodiment.

Mixers are used for frequency conversion in the second embodiment, but a sampler can be used in place of the mixers. For instance, it is possible to replace mixer 110 with a sampler that operates in accordance with the output signals of signal source 120 and to replace mixer 115 with a sampler that operates in accordance with the output signals of signal source 125. Moreover, it is also possible to feed signals under test directly to ADC 130 and ADC 135, to feed the output signals of signal source 120 to ADC 130 as the sampling block, and to feed output signals of signal source 125 to ADC 135 as the sampling block. Moreover, the sampling speed of the sampler or ADC is adjusted so that the sampler or ADC under-samples and the sampler or ADC acts as a frequency converter. It should be noted that there are cases in which additional filters become necessary for under-sampling, but these are not described here.

### WORKING EXAMPLE 1

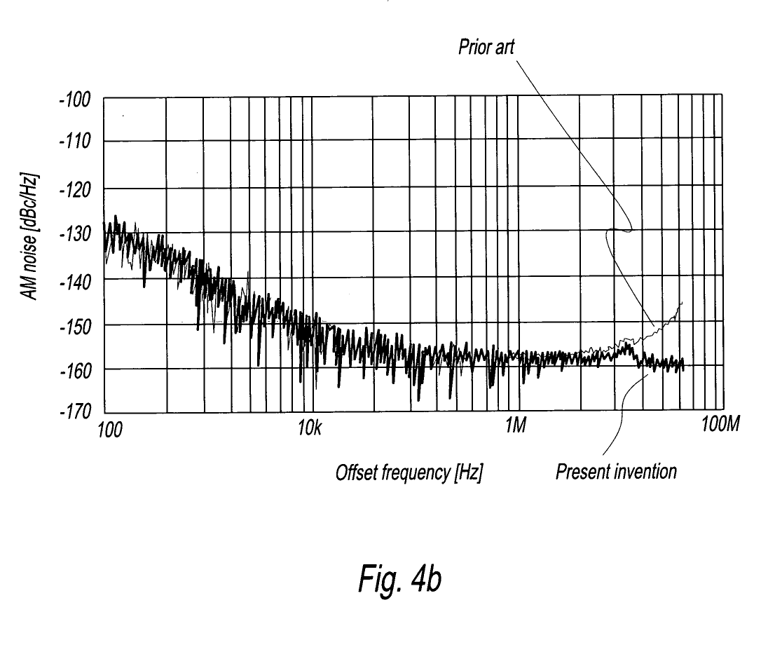

The results of the present disclosure will now be described. Refer to FIGS. 4A and 4B. FIG. 4A is a drawing showing the measurement results when the PM noise of signals under test is measured. Moreover, FIG. 4B is a drawing showing the measurement results when the AM noise of signals under test is measured. FIGS. 4A and 4B show the two types of measurement results. The two types of measurement results are both measurement results when a frequency drift was intentionally created in the signals under test. The relatively fat curve shows the results measured using the present disclosure and the relatively thin curve shows the results measured using the prior art. When a frequency drift is not produced in the signals under test, the measurement results are similar to the results measured using the present disclosure, the result found when a frequency drift was intentionally created in the signals under test; therefore, they are not illustrated. As is clear from the figures, stabilizing the frequency of the signals under test should raise measurement accuracy. For instance, looking at the offset frequency region from 100 Hz to approximately 400 kHz in FIG. 4A, it is clear that the measurement results obtained by measurement using the prior art and the measurement results obtained by measurement using the present disclosure differ by at least 10 dB. For instance, looking at the region of an offset frequency of 1 MHz or greater in FIG. 4B, it is clear that the difference between the results of measurement by the prior art and the results of measurement by the present disclosure increases with an increase in the offset frequency. The difference in these measurement results is due to the deterioration of measurement accuracy attributed to frequency drift. Measurement by the method of the present disclosure prevents this deterioration of the measurement accuracy attributed to frequency drift; as a result, the present disclosure provides results that are similar to the measurement results when there is no measurement drift in the signals under test.

What is claimed is:

1. A method for measuring the noise components of signals under test, said method for measuring noise comprising:
stabilizing the frequency of the signals under test, and
measuring the noise components of the signals under test whose frequency has been stabilized.

2. The method for measuring noise according to claim 1, further comprising correcting the measured noise components based on the properties of frequency stabilization.

3. The method for measuring noise according to claim 1, wherein stabilizing step comprises:
generating local signals;
converting the frequency of the signals under test using the local signals;
detecting the frequency of the signals under test, or the frequency of the signals under test whose frequency has been converted; and
controlling the frequency of the local signals based on the detected frequency.

4. The method for measuring noise according to claim 1, wherein said noise components are either PM noise or AM noise.

5. An apparatus for measuring noise comprising:
a frequency stabilizing unit for stabilizing the frequency of signals under test, and
a noise measuring unit for measuring the noise components of the signals under test whose frequency has been stabilized by the frequency stabilizing unit.

6. The apparatus for measuring noise according to claim 5, further comprising an arithmetic unit for correcting the measurement results of the noise measuring unit based on the properties of frequency stabilization by the frequency stabilizing unit.

7. The apparatus for measuring noise according to claim 5, wherein said frequency stabilizing unit comprises a signal source, a frequency converter to which the output signals of the signal source are fed, and a frequency detector,
wherein said frequency detector detects the frequency of the signals under test or the output signals of the frequency converter; and
wherein the frequency of the output signals of the signal source is controlled based on the frequency detected by the frequency detector.

8. The apparatus for measuring noise according to claim 5, wherein the noise components are PM noise or AM noise.
